(19) United States
(12) Patent Application Publication
(10) Pub. No.: US 2002/0003603 A1
(43) Pub. Date: Jan. 10, 2002

(54) Adjustable eye glass frames

(76) Inventor: Eston Bullard JR., Jacksonville, FL (US)

Correspondence Address: Steven R. Scott, 1228 Salt Road, Rochester, NY, 14580, US

(21) Appl. No.: 09/900,259

(22) Filed: Jul. 6, 2001

Related U.S. Application Data
(60) Provisional application No. 60/216,613, filed on Jul. 7, 2000.

(51) Int. Cl. G02C 5/20; G02C 5/04

(52) U.S. Cl. 351/118; 351/128

(57) ABSTRACT

Adjustable eyeglass frames with adjustable length sidearms and an adjustable nose saddle which adjusts up and down and has a snap-on cover.

### BACKGROUND

1. Field of the Invention

This invention relates generally to the field of eye-glass frames. More specifically, it relates to eye-glass frames that are, or seek to be, readily adjustable for the comfort of the user. In particular, it deals with novel designs for adjustable eye-glass frames that are provided with unique adjustment capabilities.

2. Prior Art in the Field

Eye-glass frames are subject to stresses in day-to-day usage that lead to them becoming loosened and out of adjustment for the wearer. This leads the glasses to constantly slide down on the wearer's nose, causing discomfort and pain, and can even lead to permanent scarring on the side of the nose. The need to keep eye-glass frames adjusted and comfortable for the wearer leads many to return on a regular basis to the location where the glasses were purchased to have the frame adjusted and tightened. Others attempt to adjust their eye-glasses themselves by bending the arms or arm-hooks thereof. In this case they may break their glasses or create other problems in that the arm-hooks may place too much tension on the ear or the head, thereby causing discomfort and possible headache.

### SUMMARY AND OBJECTS OF THE INVENTION

This invention overcomes the problems in conventional eye-glass frames by providing adjustment means for frame, arms, and arm-hooks. When adjustments are properly made using such adjustment means, a comfortable, stable precision fit may be accomplished and maintained. Well fitted glasses are essential not only for user comfort, but for the safety and efficiency of the operators of automobiles and heavy equipment and the wearers of safety glasses where such are required.

### BRIEF DESCRIPTION OF THE DRAWINGS

FIG. 1 illustrates a preferred embodiment of the instant invention from the front.

FIG. 1A provides a more detailed view of the adjustment mechanism illustrated in FIG. 1.

FIG. 1B provides a detailed view of an adjustment mechanism suitable for use in FIG. 1.

FIG. 1C illustrates a snap-on cosmetic cover adapted to cover the adjustment mechanism illustrated in the prior figures.

FIG. 2 provides a side view of a first preferred embodiment of the side-arms of the instant invention.

FIG. 3 provides an exploded view from the side of the preferred embodiment of the instant invention illustrated in FIG. 2, further illustrating the components related to adjustability of the side-arm of the glasses shown.

FIG. 4 provides a cross-sectional view of the arm of the glasses illustrated in FIGS. 2 and 3.

FIG. 5 provides a side view of a second preferred embodiment of the side-arms of the instant invention.

FIG. 6 provides an exploded view from the side of the preferred embodiment illustrated in FIG. 5, further illustrating the components related to adjustability of the side-arm of the glasses shown.

FIG. 7 provides an edge view of the adjustment ball utilized in the preferred embodiment illustrated in FIGS. 5 and 6.

### DETAILED DESCRIPTION OF THE PREFERRED EMBODIMENT

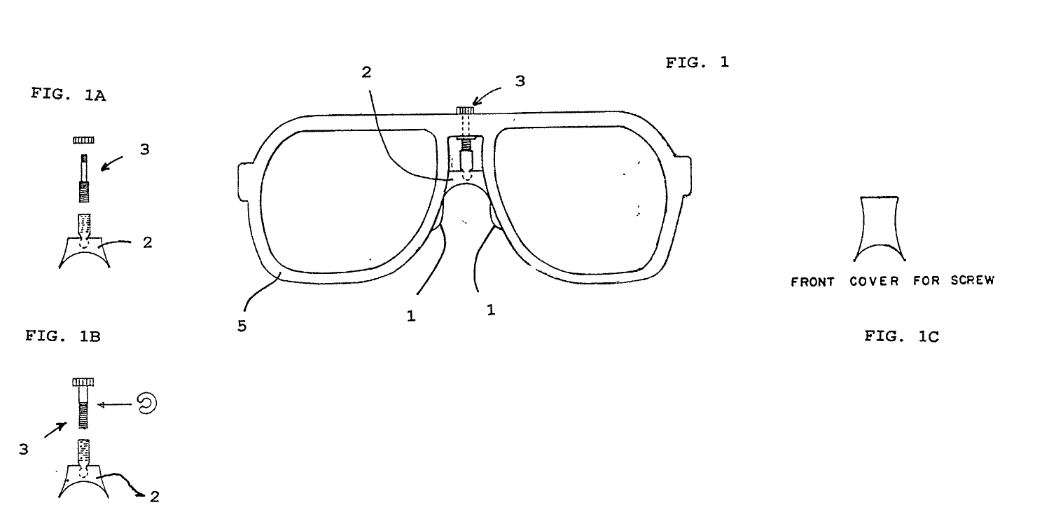

FIG. 1 provides a view from the front of a preferred embodiment of the instant invention, illustrating the conventional nose rests 1 attached to the lens frame 5. The conventional nose rests 1 of the preferred embodiments of the instant invention are similar to those found in prior art eye-glass frames. However, the saddle-like adjustable nose rest 2 provided is unique to this invention. The adjustable nose rest 2 characterizing the preferred embodiments of this invention rests on the bridge of the wearer's nose. It can be adjusted up and down for the comfort of the user via set screw 3. A more detailed view of preferred mechanisms for effecting the aforesaid adjustments is provided in FIGS. 1A and 1B. A cosmetic snap-on cover for the concealment of the operative mechanisms illustrated in FIGS. 1, 1A and 1B is illustrated in FIG. 1C.

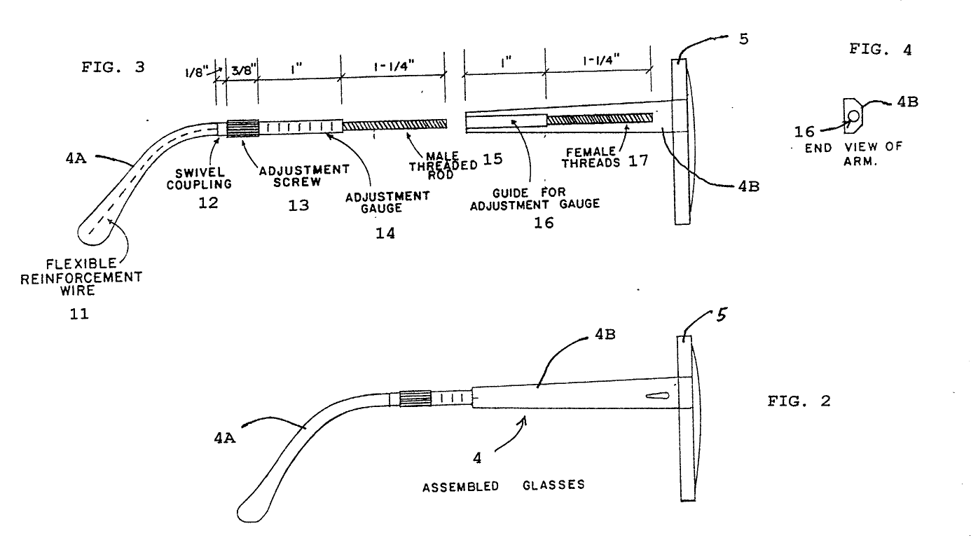

FIG. 2 provides a side view of a preferred embodiment of the instant invention, illustrating the adjustable arm 4, thereof. FIG. 3, an exploded version of FIG. 2, provides a more detailed view of the preferred mechanism for effecting the aforesaid adjustments. As will be noted from review of the drawing figures, adjustable arm 4 is comprised of a straight section 4A which is connected to the lens frame 5 and an arm hook section which terminates in an arm hook 4B adapted to hook over the human ear. A flexible reinforcement wire 11 embedded in arm hook 4B allows it to maintain its shape when adjusted (by bending) to the contours of the ear or for other purposes.

A swivel coupling 12 allows arm hook 4B to be rotated up to 360 degrees. Thus, it can be adjusted such that arm hook 4B comfortably lies between the contour of the head and ear without discomfort or, if the user desires, more snugly embraces the head of the wearer. It also isolates the movement of arm hook 4B from that of straight section 4A. This allows precision adjustment to be made in the length of adjustable arm 4 without disturbing the angle and configuration given to arm hook 4B.

The length of adjustable arm 4 can be adjusted using adjustment screw 13 to screw male threaded rod 15 into and out of female threads 17 in straight section 4A. The adjustment gauge 14 is a cylindrical section which is slidably engaged within the hollow cylindrical plenum provided by the guide for adjustment guage 16 in straight section 4A. It is inscribed with markings (as shown thereon) allowing the user to note and set the length of adjustable arm 4 to a preferred and known length suitable for the wearer's size and comfort. In the preferred embodiment illustrated, adjustment gauge 16 is one inch long, allowing up to ½ inch adjustment in and out from its center of adjustment. Considering that the instant invention would normally be manufactured in a median size the one half inch adjustment from median allowed in shortening/lengthening adjustable arm 4 should allow eye-glass frames for glasses and sunglasses manufactured in accordance with the teachings of this invention to fit more than 90% of the population.

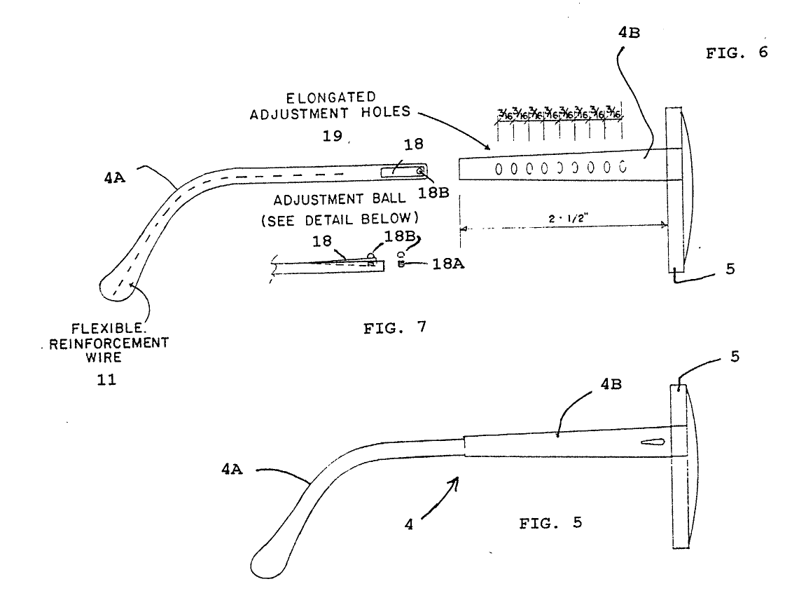

An alternate method and apparatus for adjusting the length of adjustable arm 4 is shown in the embodiment illustrated in FIGS. 5, 6 and 7. In this embodiment, arm hook 4B is essentially cylindrical at the end adjacent straight section 4B. This end can, therefore, be slidably engaged within a cylindrical plenum in straight section 4B as was the case in the prior embodiment. Adjustable arm 4 can be affixed at a certain desired length via the provision of a spring biased segment 18 having a spring 18A which forces the semispherical adjustment ball 18B of segment 18 into engagement in one of the elongated adjustment holes 19 provided between the exterior of straight section 4B and the cylindrical plenum therein. To readjust the length of adjustable arm 4, semispherical adjustment ball 18B can be pushed back out of the elongated adjustment hole 19 in which it is engaged, allowing the end of arm hook 4B engaged in straight section 4B to be slid farther in or out thereof.

The vertical lengthening of elongated adjustment holes 19 allow slight rotation of arm hook 4B (approximately ⅛ inch in or out) around the axis of the cylindrical plenum in straight section 4B. This feature therefore serves somewhat the same purpose as the swivel coupling 12 of the prior embodiment discussed. As will be noted from review of FIG. 5, the adjustment mechanism shown in FIGS. 6 and 7 and discussed supra is positioned on the inside of adjustable arms 4 so that segment 18 and elongated holes 19 do not show when the embodiment is in use.

1. Adjustable eyeglass frames, comprising:
a) a frontal eyeglass lens holding frame having an upper portion;
b) two side arms, each having a first end connected to said frontal eyeglass lens holding frame and a second end for placement over a user's ears; and
c) an adjustable nose saddle adjustable up and down with regard to the upper portion of said frontal eyeglass lens holding frame.

2. Adjustable eyeglass frames, as described in claim 1, wherein a bridge connects a left lens holding portion of the frontal eyeglass lens holding frame to the right lens holding portion of the frontal eyeglass lens holding frame and an actuator for adjusting said nose saddle is connected to said bridge.

3. Adjustable eyeglass frame, as described in claim 2, wherein said actuator is an adjustment screw connected to said saddle.

4. Adjustable eyeglass frames, comprising:
a) a frontal eyeglass lens holding frame having an upper portion;
b) two side arms, each having a first end connected to said frontal eyeglass lens holding frame and a second end for placement over a user's ears; and
c) a side arm length adjustor between the first end and the second end of each of said two side arms.

5. Adjustable eyeglass frames, as described in claim 4, wherein a side arm adjustor of one of said two side arms uses a screw threaded coupling between said first end and said second end to adjust the length of said one side arm.

6. Adjustable eyeglass frames, as described in claim 4, wherein a side arm adjustor of one of said two side arms uses a sliding snap catch coupling between said first end and said second end to adjust the length of said one side arm.

7. Adjustable eyeglass frames, as described in claim 4, further comprising an adjustable nose saddle adjustable up and down with regard to the upper portion of said frontal eyeglass lens holding frame.

8. Adjustable eyeglass frames, as described in claim 7, wherein a bridge connects a left lens holding portion of the frontal eyeglass lens holding frame to the right lens holding portion of the frontal eyeglass lens holding frame and an actuator for adjusting said nose saddle is connected to said bridge.

9. Adjustable eyeglass frames, as described in claim 8, wherein said actuator is an adjustment screw connected to said saddle.

10. Adjustable eyeglass frames, as described in claim 8, further comprising a snap-on cover for said actuator.

11. Adjustable eyeglass frames, as described in claim 5, further comprising an adjustable nose saddle adjustable up and down with regard to the upper portion of said frontal eyeglass lens holding frame.

12. Adjustable eyeglass frames, as described in claim 11, wherein a bridge connects a left lens holding portion of the frontal eyeglass lens holding frame to the right lens holding portion of the frontal eyeglass lens holding frame and an actuator for adjusting said nose saddle is connected to said bridge.

13. Adjustable eyeglass frames, as described in claim 12, wherein said actuator is an adjustment screw connected to said saddle.

14. Adjustable eyeglass frames, as described in claim 12, further comprising a snap-on cover for said actuator.

15. Adjustable eyeglass frames, as described in claim 6, further comprising an adjustable nose saddle adjustable up and down with regard to the upper portion of said frontal eyeglass lens holding frame.

16. Adjustable eyeglass frames, as described in claim 15, wherein a bridge connects a left lens holding portion of the frontal eyeglass lens holding frame to the right lens holding portion of the frontal eyeglass lens holding frame and an actuator for adjusting said nose saddle is connected to said bridge.

17. Adjustable eyeglass frames, as described in claim 16, wherein said actuator is an adjustment screw connected to said saddle.

18. Adjustable eyeglass frames, as described in claim 16, further comprising a snap-on cover for said actuator.

19. Adjustable eyeglass frames, as described in claim 2, further comprising a snap-on cover for said actuator.

20. Adjustable eyeglass frames, as described in claim 1, further comprising a swivel coupling between said first end and said second end.

21. Adjustable eyeglass frames, as described in claim 4, further comprising a swivel coupling between said side arm length adjustor and said second end.

22. Adjustable eyeglass frames, as described in claim 5, further comprising a swivel coupling between said side arm length adjustor and said second end.

23. Adjustable eyeglass frames, as described in claim 6, further comprising a swivel coupling between said side arm length adjustor and said second end.
